(19) United States
(12) Patent Application Publication
(10) Pub. No.: US 2008/0278056 A1
(43) Pub. Date: Nov. 13, 2008

(54) COMPACT FLUORESCENT LAMP WITH OUTER BULB

(75) Inventors: Sandor Lukacs, Nyar (HU); Jozsef Tokes, Jozsef Attila (HU); Jozsef Fulop, Napoly (HU)

Correspondence Address: FAY SHARPE LLP, 1100 SUPERIOR AVENUE, SEVENTH FLOOR, CLEVELAND, OH, 44114, US

(73) Assignee: General Electric Company

(21) Appl. No.: 11/859,623

(22) Filed: Sep. 21, 2007

(30) Foreign Application Priority Data
May 10, 2007 (HU) P0700332

(51) Int. Cl. H01J 61/32; F21V 21/00

(52) U.S. Cl. 313/491; 362/396

(57) ABSTRACT

A compact fluorescent lamp having an arc tube is disclosed. The arc tube comprises: at least a first tube part and a second tube part connected to each other through a transverse connecting tube portion including a cold spot. The lamp further comprises an outer bulb enclosing the arc tube. A clip member is adapted to clip to the connecting tube portion. The clip member is for providing heat dissipation from the cold spot and for providing resilient positioning for the arc tube along a longitudinal axis of the lamp. The clip member is comprised of:
at least one gripping section adapted to clip on said connecting tube portion diametrically around, and made of a curved resilient metallic strip;
at least two resilient outward tags protruding out from the gripping section in different directions for providing flexible support on an inner surface portion of the outer bulb. The outward tags are made of metal and having contacting sections for sprung contact onto the inner surface portion of the outer bulb.

### FIELD OF THE INVENTION

This invention relates to compact fluorescent lamps, more particularly to compact fluorescent lamps that can replace incandescent lamps of general purpose. Even more specifically the invention relates to low-pressure compact fluorescent lamps that have an outer bulb and a ballast circuit within the outer bulb.

### BACKGROUND OF THE INVENTION

At present, most of the commercially available known low-pressure discharge lamps are of the kind of so-called compact fluorescent lamps (CFL). This kind of lamps is capable of replacing commonly used incandescent lamps used generally in industrial and home applications. Main advantages of these lamps are the low power consumption and the long lifetime. In order to reduce overall length of a CFL and still keeping its high luminous output, an arc tube of sufficient length is required. For this double purpose, the arc tube is usually formed or configured in a manner to obtain a multiple tube arrangement. Many forms have already been proposed, including several kinds of coiled tube arrangements. Some of these CFL constructions have an outer bulb having essentially the same shape as the shape of conventional incandescent lamp bulbs. The outer bulb can be made of glass or synthetic material.

In one kind of these constructions, the glass arc tube has a double-spiral structure that is made up of a turning part, a first spiral part, and a second spiral part, while the connecting turning part is positioned about in the middle between both ends of the glass arc tube. A first spiral part is starting from one end of the glass tube and being coiled around a longitudinal lamp axis toward the turning part, the second spiral part is starting from the turning part and being coiled around the lamp axis toward the other end of the arc tube. The coolest point of the arc tube within the turning part, the so-called cold spot determines the luminous efficiency of the arc tube, i.e. the CFL.

Known CFL-s usually contain mercury-controlling amalgam, because of the high inside temperature in the arc tube. The amalgam is capable of maintaining the optimum mercury vapor pressure inside the discharge vessel, but usually causes long warm up time. This warm up time can be longer than 2 minutes, which results in undesired low starting performance. Non-amalgam filling composition is not able to perform the same light output as the light output available with the use of amalgam due to hot surface temperature of the arc tube.

To keep advantages of amalgam lamp and to reduce disadvantages of non-amalgam version, the only solution is to maintain cold spot temperature of the lamp below at least about 50° C. It is, however, a disadvantage of the coiled tube CFL-s, especially when an outer bulb is applied, that the cooling of the arc tube is bad and consequently the cold spot temperature may be too high.

According to a solution disclosed in WO03/043055 A2, a heat-conductive member is formed in a vicinity of the turning part of the arc tube of the lamp. The heat from the cold spot is conducted to the outer bulb via the heat-conductive member. As disclosed, one of metal, rubber and resin is used as the material of the heat-conductive member in the form of an intermediate bulk piece. In particular, a transparent silicone resin is proposed as the material of the heat-conductive member. Transparency is necessary, since the bulk of the heat-conductive member blocks the emitted light in a considerable area of the arc tube. While this heat-conductive member can promote the conductive cooling, the circulation of the air between the arc tube and the outer bulb will be obstructed by the bulky structure and thus an important other kind of cooling inside the outer bulb is lowered.

To put in place a bulky heat-conductive member between the arc tube and the outer bulb is not easy during manufacturing, and the bulky heat-conductive member makes the CFL sensitive to external dynamic effects since it is not sufficiently resilient to absorb impulsive forces.

In order to conduct the heat from the arc tube to the outer bulb even more effectively, a swelling portion is proposed by WO03/043055 A2, which may optionally be provided for increasing an area where the arc tube and the heat-conductive member are contacted.

Furthermore, there is a problem with this kind of CFL-s if the ballast is within or at least partially within the outer bulb and produces additional heat, and also increases the operating temperature of the cold spot. Therefore in order to obtain better luminance properties, the temperature of the cold spot of the arc tube must be lowered even more effectively.

There is a need for compact fluorescent lamps with cold spot that have an arc tube of coiled form and at least partially a ballast in an outer bulb and means for reducing the temperature of the cold spot and resiliently positioning the arc tube.

There is also a need for avoiding unnecessary loss of the emitted light while reducing the temperature of the cold spot.

There is also need for a cheap and easy to manufacture means for use with different kinds and forms of compact fluorescent lamps.

### SUMMARY OF THE INVENTION

In an exemplary embodiment of the present invention, there is provided a compact fluorescent lamp having a longitudinal axis and comprising:

an arc tube being formed of a bent glass arc tube, enclosing a discharge volume filled with a discharge gas and having a fluorescent coating disposed on an inner surface portion thereof, the arc tube comprising at least a first tube part and a second tube part connected to each other through a connecting tube portion; the arc tube determining an arc path and further being provided with electrodes disposed at each end of the arc path; the connecting tube portion being substantially transverse to the longitudinal axis of the lamp and comprising a cold spot within the arc tube;

an outer bulb comprising a substantially spherical portion enclosing at least the arc tube, and a substantially elongated end portion;

a ballast circuit being at least partially within the outer bulb for controlling current through the arc tube and being connected to said electrodes;

a lamp base being connected to the end portion of the outer bulb;

a clip member of metallic material adapted to clip to said connecting tube portion for providing heat dissipation from the cold spot in the connecting tube portion and for providing resilient positioning for the arc tube along said longitudinal axis, the clip member comprising:

at least one gripping section adapted to clip on said connecting tube portion diametrically around, and made of a curved resilient metallic strip;

at least one resilient outward tag protruding out from the gripping section for providing flexible support on an inner surface portion of the outer bulb, the outward tags having contacting sections for sprung contact onto the inner surface portion of the outer bulb.

In an exemplary embodiment of another aspect of the present invention a clip member for a compact fluorescent lamp is proposed. The clip member is adapted to clip to a connecting tube portion between a first tube part and a second tube part of a bent glass arc tube of a compact fluorescent lamp having an outer bulb. The clip member is for providing heat dissipation from a cold spot in the connecting tube portion and for providing resilient positioning for the arc tube along a longitudinal axis of the lamp. The clip member is comprised of:

at least one gripping section adapted to clip on said connecting tube portion diametrically around, and made of a curved resilient metallic strip;

at least two resilient outward tags protruding out from the gripping section in different directions for providing flexible support on an inner surface portion of the outer bulb, the outward tags being made of metal and having contacting sections for sprung contact onto the inner surface portion of the outer bulb.

This invention has several advantages over the prior art. The compact fluorescent lamp with the clip member provides for an efficient heat conduction from the cold spot to the outer bulb and consequently to the environment thereof. The cold spot temperature of the lamp can be successfully maintained below the temperature of about 50° C. The clip member contributes to a resilient positioning of the arc tube as well. Due to a non-bulky and airy structure, circulation of the air between the arc tube and the outer bulb is scarcely obstructed, and the light emitted by the arc tube is not affected significantly. A compact fluorescent lamp with the resiliently structured clip member is less sensitive to external dynamic effects with respect to the prior art lamps with heat-conductive members. The clip member proposed can be manufactured and mounted into the lamp easily.

### BRIEF DESCRIPTION OF THE DRAWINGS

The invention will now be described in detail with reference to the enclosed drawing, in which

FIG. 1 is a side view in partial cross section, showing an embodiment of a lamp according to the invention,

FIG. 2 is a broken perspective view of the lamp of FIG. 1,

FIG. 3 is a side view of an embodiment of the clip member having two gripping sections,

FIG. 4 is a front view of the clip member of FIG. 3,

FIG. 5 is a top view of the clip member of FIG. 3,

FIG. 6 is a perspective view of the clip member of FIG. 3,

FIG. 7 is a side view of a further embodiment of the clip member having one gripping section,

FIG. 8 is a front view of the clip member of FIG. 7,

FIG. 9 is a top view of the clip member of FIG. 7,

FIG. 10 is a perspective view of the clip member of FIG. 7,

FIG. 11 is a perspective view of another embodiment of the clip member with a single outward tag.

### DETAILED DESCRIPTION OF THE INVENTION

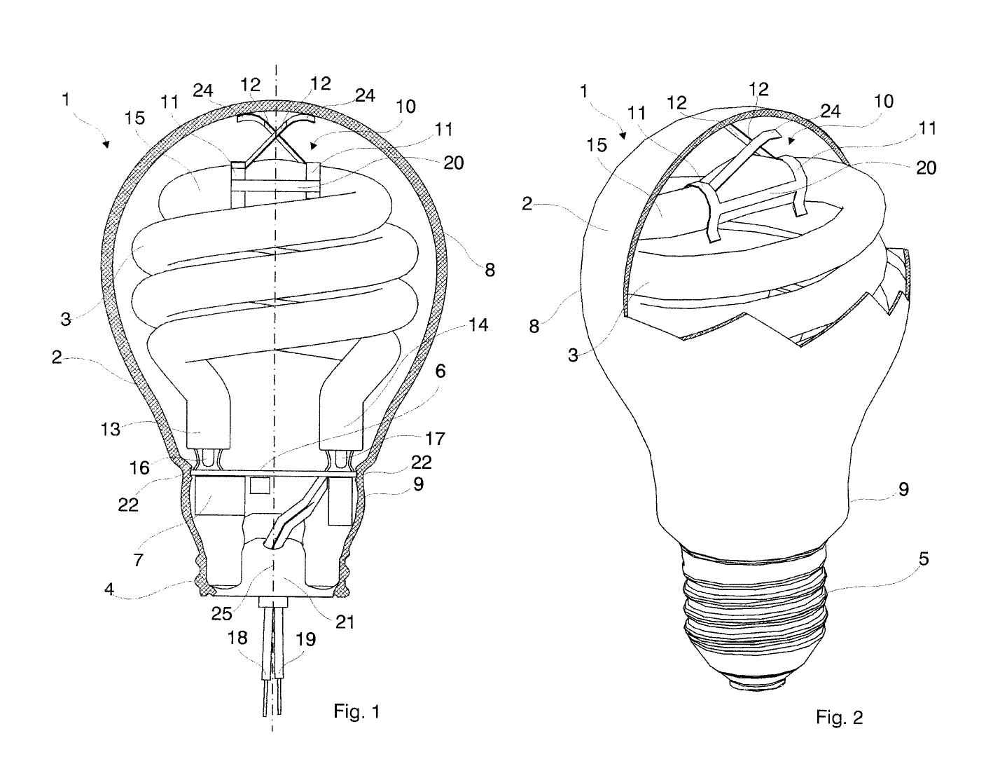

Referring first to FIG. 1, a low-pressure discharge lamp 1 is shown. The lamp is a fluorescent discharge lamp, with an outer bulb 2 enclosing an arc tube 3 and a ballast circuit 7. The outer bulb 2 has a spherical portion 8 and an elongated end portion 9 with a neck portion 4 connected to a lamp base 5 (FIG. 2). The outer bulb 2 contains the ballast circuit 7. The ballast protruding into the inner space of the elongated end portion 9 of the outer bulb 2 is attached to a mounting plate 6 as it is shown in FIG. 1. This mounting plate 6 may provide support for the lower part of the arc tube 3 and may be fixed by an inside rim 22 in the elongated end portion 9 of the outer bulb 2.

The lamp 1 is provided with electrodes located at the ends 16 and 17 of the arc tube 3 and electric current is supplied through wires 18 and 19 to these electrodes. The wires 18 and 19 are led through a stem 21 in this example. The wires 18 and 19 are connected to the to the lamp base 5 in a known and commonly used manner.

The arc tube 3 is formed as a bent glass tube, enclosing a discharge volume filled with a discharge gas and having a fluorescent coating disposed on the inner surface of the tube 3. The arc tube 3 comprises at least a first tube part 13 and a second tube part 14 connected to each other through a connecting tube portion 15. The whole arc tube 3 determines an arc path and is provided with electrodes disposed at each end 16 and 17 of the arc path. The connecting tube portion 15 is substantially transverse to a longitudinal axis 25 of the lamp 1 and comprises a so-called cold spot within the arc tube 3. The cold spot is the place along the arc tube 3 where the discharge arc has the lowest temperature, i.e. the coolest point of the arc tube. In order to accomplish sufficient luminous efficiency, this point has to be kept at a temperature below about 50° C.

The ballast circuit 7 is at least partially within the outer bulb 2. The function of the ballast circuit 7 is to control current through the arc tube 3, and it is connected to the arc tube through the electrodes in the ends 16 and 17 of the arc tube 3.

As shown in FIG. 2, the lamp base 5 is connected to the end portion 9 of the outer bulb 2. The outer bulb comprises fixtures for said arc tube 3 and/or said ballast circuit 7. By the example of FIG. 1, the fixation is performed by the mounting plate 6 and the inside rim 22 supporting the mounting plate 6.

In FIG. 2, a partial broken perspective view of the lamp of the exemplary embodiment of the invention is shown where the outer bulb 2 of the lamp 1 comprises a substantially spherical portion 8 enclosing the arc tube 3 and a substantially elongated end portion 9, and the spherical portion 8 and the end portion 9 commonly have a longitudinal axis, which is identical with the lamp axis 25 itself.

In order to provide cooling and positioning of the arc tube along the longitudinal axis 25 of the lamp according to the exemplary embodiment of the invention, a clip member 10 of metallic material is adapted to encompass the connecting tube portion 15 for providing heat dissipation from the cold spot in the connecting tube portion 15 and for providing resilient positioning for the arc tube along said lamp axis 25. The clip member 10 comprises at least one gripping section 11 adapted to clip on the connecting tube portion 15 diametrically around, and is made of a curved resilient metallic strip. The clip member 10 also comprises at least one resilient outward tag 12 that protrudes out from the gripping section 11 for providing flexible support on an inner surface portion of the outer bulb 2. The material of the metallic strip of the gripping section 11 and the outward tags may be a resilient sheet metal plate, such as brass or copper. Otherwise any other metal of good heat conductivity might be chosen.

In FIGS. 1 and 2, the clip member 10 attached by clipping onto the connecting tube portion 15 has two parallel gripping sections 11 for this purpose. The gripping sections 11 are made of strips cut out from sheet material of a resilient metal. The metal can be copper, brass or other resilient metal or alloy of sufficient heat conductivity. It can be seen in FIGS. 4 and 5 that the gripping sections 11 are bent to a shoe shape. The better fits the shoe-shaped gripping section to the cross-sectional shape of the connecting tube portion 15 diametrically around, the more effective heat bridge is formed between the clip member 10 and the cold spot.

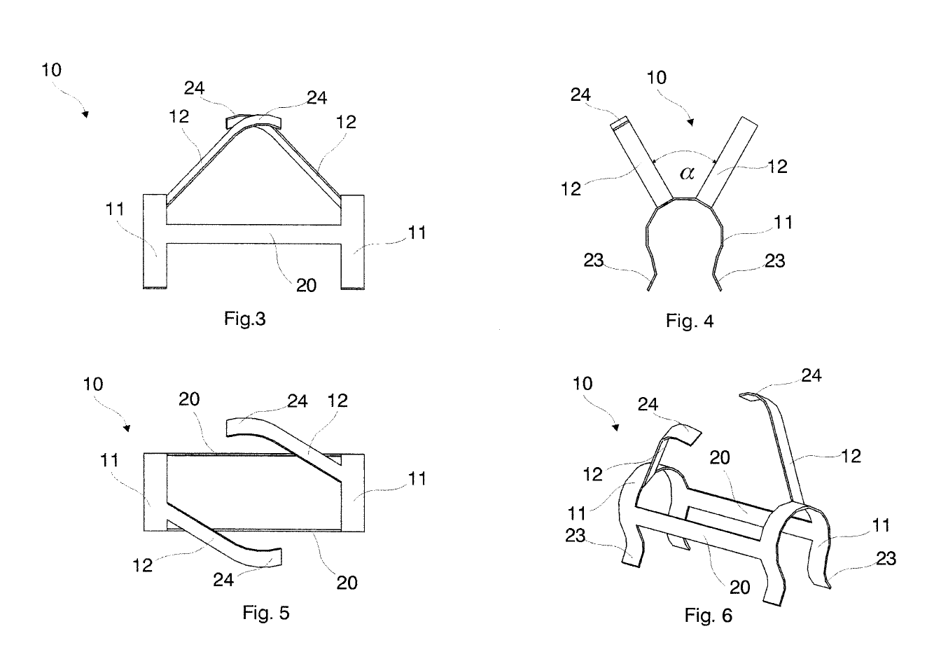

The two gripping sections 11 are connected to each other, as seen in FIGS. 3, 4 and 6, by two longitudinal traverse members 20. In other embodiments, more than two traverse members are also applicable. The traverse members 20 preferably are substantially parallel to the connecting tube portion 15, and have a width of 1-2 mm only in order to minimize blocking of the emitted light from the arc tube 3.

The strips of the gripping sections 11 usually have a width of 1-4 mm, which is necessary for gathering heat for the outward tags 12 that conduct the heat to the outer bulb 2.

In FIGS. 4 and 6, the gripping sections 11 are bent to a shoe shape with splay endings 23. This results a Q shape, the lower opening of which is capable of clipping onto a tube easier. The endings 23 provide guidance during clipping motion.

As it is shown in FIG. 3, two resilient outward tags 12 are provided for flexible support on the inner surface of the outer bulb 2 of the lamp 1. The outward tags 12 are attached to the gripping sections 11 each, and protrude from the two gripping sections 11 in different outward directions, as shown in the front view of FIG. 4 and in the top view of FIG. 5, as well. This means that the outward tags 12 define different protruding directions with respect to the plane that is tangential to the surface of the arc tube 3.

The outward tags 12 are made of a resilient metal as well, and in one embodiment have rounded contacting sections 24 for sprung contact onto the inner surface of the outer bulb 2 of the lamp 1. In the embodiment illustrated in FIGS. 3-6, the outward tags 12 are made of bent strips. The material of the metallic strips of the outward tags 12 may be the same as that of the gripping sections 11. In this way, the outward tags 12 may be of a resilient sheet metal plate, such as brass or copper. Otherwise any other metal of good heat conductivity may be selected.

The rounded contacting sections 24 of the outward tags 12 are, for example, outwardly convex curved sections near the free end of the outward tags 12, as sown in the figures. The outward tags 12 have outwardly convex curved sections of a radius smaller than the smallest radius of curving of the outer bulb 2.

In an embodiment, the metal strips of the outward tags may be split over a length starting at their free ends. This may enhance the cooling capability and distribute the supporting force on the inner surface of the outer bulb, thus providing higher stability. The metal strips of the split parts of the outward tags 12 may be both bent out over a length starting from their free ends.

It is shown in FIG. 4 that the outward tags 12 protrude out from the two gripping sections 11 in different outward directions that are in planes which close an angle α. This arrangement ensures a good self-alignment feature for the clip member 10 when the lamp 1 is assembled. Also the heat dissipation areas on the inner surface of the outer bulb 2 can be farther from each other in this way. The angle α can be, for example, selected between 5 and 90 degrees in the embodiments of FIGS. 3-6. Of course, other values can also be selected for angle α in different embodiments. If α is chosen to zero, the outward tags connected to each gripping section are in directions converging to each other.

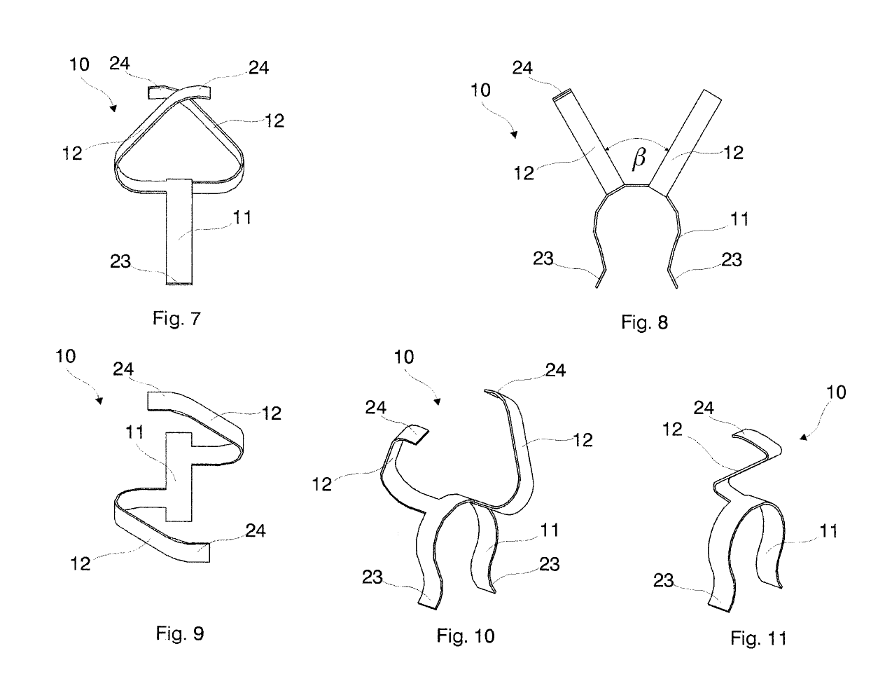

A further embodiment of the clip member 10 with single gripping section 11 is illustrated in FIGS. 7, 8, 9 and 10 in different views. FIG. 7 is a side view of the clip member 10 comprising one gripping section 11 adapted to clip on the connecting tube portion 15 of the arc tube 3 diametrically around, and made of a curved resilient metallic strip. The two outward tags 12 protrude out from the single gripping section 11 on both sides, and are bent in different outward directions diverging from each other, which provide different contact spots on the inner surface of the outer bulb. For this purpose, the outward tags 12, which are also made of a resilient metal, have rounded contacting sections 24 similarly to the contacting section 24 of the previously described embodiment. This is the case with the shoe shape gripping section 11 having splay endings 23 as well. The outward tags 12 on both sides are bent back and thus protrude out in such a manner that their different outward directions are in planes which close an angle β. The angle β can be, for example, chosen between 5 and 90 degrees in the embodiments of FIGS. 7-10. Of course, other values of the angle β may also be selected in different embodiments.

FIG. 11 shows a further embodiment, in which only one outward tag 12 protrudes out from one side of a single gripping section 11. The single outward tag 12 is bent twice and thus results in a Z shape with a contacting section 24. This embodiment also performs the function of heat dissipation and resilient positioning of the arc tube along the longitudinal axis 25 of the lamp at the same time.

In both embodiments of FIGS. 3-6 and FIGS. 7-11, the outward tags 12 may have a width of 1-4 mm, which provides sufficient heat conduction but still a limited blocking of light. In order to further diminish the latter, a light-reflecting layer may cover the clip member 10. The clip member may be manufactured as a single piece by cutting out of a sheet material. If the clip member is assembled of a plurality of elements, the outward tags 12 or the transverse members 20 may be attached to the gripping sections for example by welding. The clip member 10 can be mounted on the arc tube of the compact fluorescent lamp easily during manufacturing.

The outward tags 12 can be manufactured not only from strips. For example, elements made of wires or the like can also be used. The attachment of the outward tags to the gripping sections 11 may be performed for example by welding in these cases.

When the arc tube with its accessories, such as ballast and lead-in wires or the like, is under insertion into the outer bulb, the clip member provides self-alignment guidance in cooperation with the outer bulb. This may constitute a resilient chocking in the assembled compact fluorescent lamp.

The invention is not limited to the shown and disclosed embodiments, but other elements, improvements and variations are also within the scope of the invention. For example, it is clear for those skilled in the art that several different forms of the outer bulb may be applicable for the purposes of the present invention. The lower support of the arc tube may also be different. The form and segmentation of the arc tube may also vary according to size or desired power output of the lamp.

1. A compact fluorescent lamp having a longitudinal axis and comprising:
an arc tube being formed of a bent glass tube enclosing a discharge volume filled with a discharge gas and having a fluorescent coating disposed on an inner surface portion thereof, the arc tube comprising at least a first tube part and a second tube part connected to each other through a connecting tube portion; the arc tube determining an arc path and further being provided with electrodes disposed at each end of the arc path; the connecting tube portion being substantially transverse to the longitudinal axis of the lamp and comprising a cold spot within the arc tube;
an outer bulb comprising a substantially spherical portion enclosing at least the arc tube, and a substantially elongated end portion;
a ballast circuit being at least partially within the outer bulb for controlling current through the arc tube and being connected to said electrodes;
a lamp base being connected to the end portion of the outer bulb;
a clip member of metallic material adapted to clip to said connecting tube portion for providing heat dissipation from the cold spot in the connecting tube portion and for providing resilient positioning for the arc tube along said longitudinal axis, the clip member comprising:
at least one gripping section adapted to clip on said connecting tube portion diametrically around, and made of a curved resilient strip;
at least one resilient outward tag protruding out from the gripping section for providing flexible support on an inner surface portion of the outer bulb, the outward tags having contacting sections for sprung contact onto the inner surface portion of the outer bulb.

2. The compact fluorescent lamp of claim 1, in which two resilient outward tags protrude out from the at least one gripping section in different directions.

3. The compact fluorescent lamp of claim 1, in which a mounting plate is attached to the end portion of the outer bulb for supporting the first tube part and the second tube part.

4. The compact fluorescent lamp of claim 1, in which the outward tags are made of one of the metals of the group containing copper and brass.

5. The compact fluorescent lamp of claim 1, in which the outward tags are made of a metal strip.

6. The compact fluorescent lamp of claim 5, in which the width of the metal strip of the outward tags is 1-4 mm.

7. The compact fluorescent lamp of claim 1, in which the contacting sections of the outward tags form outwardly convex curved sections near to free end of the outward tags.

8. The compact fluorescent lamp of claim 7, in which the outward tags have outwardly convex curved sections of a radius smaller than the smallest radius of curving of the outer bulb.

9. The compact fluorescent lamp of claim 5, in which the metal strips are split over a length from free ends thereof.

10. The compact fluorescent lamp of claim 1, in which said clip member is comprised of:
at least two gripping sections adapted to clip on said connecting tube portion diametrically around, and made of a curved resilient strip;
at least two traverse members connecting the gripping sections along the connecting tube portion.

11. A clip member adapted to clip to a connecting tube portion between a first tube part and a second tube part of a bent glass arc tube of a compact fluorescent lamp having an outer bulb, said clip member providing for heat dissipation from a cold spot in the connecting tube portion and resilient positioning of the arc tube along a longitudinal axis of the lamp, said clip member comprising:
at least one gripping section adapted to clip on said connecting tube portion diametrically around, and made of a curved resilient metallic strip;
at least two resilient outward tags protruding out from the gripping section in different directions for providing flexible support on an inner surface portion of the outer bulb, the outward tags being made of metal and having contacting sections for sprung contact onto the inner surface portion of the outer bulb.

12. The clip member of claim 11, in which the clip member is cut out of a metallic sheet material as a single piece, and folded and bent to form the gripping section and the outward tags.

13. The clip member of claim 11, in which the clip member is made of one of the metals of the group containing copper and brass.

14. The clip member of claim 11, in which the width of the outward tags is 1-4 mm.

15. The clip member of claim 11, in which the contacting sections of the outward tags form outwardly convex curved sections near to free end of the outward tags.

16. The clip member of claim 11, in which the outward tags have outwardly convex curved sections of a radius smaller than the smallest radius of curving of the outer bulb.

17. The clip member of claim 11, in which the outward tags are split over a length from free ends thereof.

18. The clip member of claim 17, in which the split parts of the outward tags are spread out over a length from the free ends thereof.

19. The clip member of claim 11, in which said clip member is comprised of
at least two gripping sections adapted to clip on said connecting tube portion diametrically around, and made of a curved resilient strip;
at least two traverse members connecting the gripping sections.

20. The clip member of claim 11, in which said gripping sections are bent to a shoe shape.

21. The clip member of claim 11, in which said gripping sections are bent to a shoe shape with splay endings.

22. The clip member of claim 11, in which the outward tags are welded to the gripping section.

23. The clip member of claim 19, in which said clip member comprises two gripping sections and the outward tags are connected to each gripping section in directions converging to each other.

24. The clip member of claim 23, in which the outward tags protrude out from the two gripping sections in different directions being in planes closing an angle α.

25. The clip member of claim 23, in which the gripping sections have a width of 1-4 mm.

26. The clip member of claim 11, in which said clip member comprises one single gripping section and two outward tags connected to the gripping section in directions diverging from each other.

27. The clip member of claim 26, in which the outward tags protruding out of the single gripping section on both sides thereof are bent back in different directions.

28. The clip member of claim 26, in which the outward tags protrude out from the single gripping section in different directions being in planes closing an angle β.

29. The clip member of claim 26, in which the gripping section has a width of 1-4 mm.

30. The clip member of claim 19, in which the traverse members have a width of 1-2 mm.

31. The clip member of claim 11, in which a light reflecting coating is applied to the surface thereof.
